(19) United States
(12) Patent Application Publication
(10) Pub. No.: US 2012/0105576 A1
(43) Pub. Date: May 3, 2012

(54) Arrangement of a Rotary Image Capture Unit for Imaging Objects on Circuit Boards at a Polar Viewing Angle 45º

(76) Inventors: André Hacke, Griez (DE); Romin Richter, Jenn (DE)

(21) Appl. No.: 13/264,506

(22) PCT Filed: Apr. 14, 2010
(86) PCT No.: PCT/DE2010/050020

§ 371 Date: Nov. 21, 2011

(30) Foreign Application Priority Data
Apr. 15, 2009 (DE) 10 2009 017 694.2

(51) Int. Cl. H04N 7/18

(52) U.S. Cl. 348/36; 348/E07.085

(57) ABSTRACT

The invention is directed to a rotary image capture unit for imaging objects on printed circuit boards at a polar viewing angle of 45°. The object of the invention is to provide a possibility for realizing an object inspection from different, finely adjustable viewing angles (azimuth angle and polar angle) in the most economical manner possible. According to the invention, this object is met by a rotary image capture unit for imaging objects on printed circuit boards, preferably at an angle of 45° in that an imaging assembly comprising a cable feed, a video camera (1), an adapter (3), an objective (4), a mirror (7), a mirror illumination unit (8), an illumination unit (9), a controlling and regulating unit (10), a cover glass (11), and a diffusion disk (12) is arranged so as to be rotatable in its entirety at an angle between 0° and 360°.

### RELATED APPLICATIONS

The present application is a U.S. National Stage Application of International PCT Application No. PCT/DE2010/050020 filed on Apr. 14, 2010 which claims priority benefit of German Application No. DE 10 2009 017 694.2 filed on Apr. 15, 2009, the contents of which are incorporated herein by reference in their entirety.

### FIELD OF THE INVENTION

The invention is directed to a rotary image capture unit for imaging objects on printed circuit boards at a polar viewing angle of 45°, particularly for checking solder joints in integrated circuits and discrete components. Other applications include the inspection of two-dimensional objects such as, for example, solar panels and wafers in semiconductor fabrication.

### BACKGROUND OF THE INVENTION

During the fabrication process, electronic circuit board assemblies run through the technical steps of paste printing, populating and soldering. After soldering, the electronic circuit board assemblies are typically checked for manufacturing defects by means of an automatic optical inspection device.

In this connection, the inspection of solder joints poses a special challenge. The reliability of solder joint inspection depends upon the information contained in the image captured by the video camera.

To increase the reliability of solder joint inspection, it is necessary to improve the imaging/illumination unit. Besides improving illumination, this includes being able to view the objects to be inspected at different azimuth angles and polar angles.

Proposed solutions for the inspection of electronic components and solder joints on printed circuit boards which allow imaging from optionally selectable directions and perspectives are known from the patent literature. U.S. Pat. Nos. 5,064,291 and 5,862,973 describe the inspection of objects from different viewing angles (azimuth angles, polar angles) through the use of a plurality of statically arranged cameras at different positions. These arrangements have the disadvantages of a very rough distribution of viewing angle directions, extensive material input (one camera objective unit per angular position) and the high costs resulting from this.

In U.S. Pat. No. 6,771,805 B1, the inspection of components and/or solder joints and the imaging required for this purpose are carried out by means of a movable mirror unit (single mirror) followed by an objective and a detector (camera). By manipulating the mirror orientation, it is possible to bring about a change in the polar viewing angle. It is necessary to rotate the object under inspection (printed circuit board) to ensure a change in the azimuth viewing angle. This arrangement of elements and the resulting imaging process lead to several great disadvantages.

In addition to the desired change of perspective, variation of the mirror unit causes a lateral displacement of the field of view on the object under inspection. The occurring lateral displacement must be compensated in a corresponding manner during inspection of a selected location of given coordinates on the object under inspection. A further disadvantage consists in that the usable size of the field of view decreases as the polar angle increases. This is a result of the limited depth of focus in the optical imaging. While the depth of focus range can be increased again through corresponding adjustment of the aperture stop of the optics, the accompanying loss in resolving power and intensity severely limit this approach.

Further, handling of the object under inspection through rotation is very disadvantageous if this method is to be used in a system for automatic inspection under industrial conditions.

### OBJECT OF THE INVENTION

It is the object of the invention to provide a possibility for realizing an object inspection from different, finely adjustable viewing angles (azimuth angle and polar angle) in the most economical manner possible.

According to the invention, this object is met through an arrangement of a rotary image capture unit for imaging objects on printed circuit boards, preferably at the polar angle of 45°, which is characterized in that an imaging assembly comprising a cable feed, a video camera, an adapter, an objective, a mirror, a mirror illumination unit, an illumination unit, a controlling and regulating unit, a cover glass, and a diffusion disk is arranged so as to be rotatable in its entirety at an angle between 0° and 360°, in that the video camera is arranged at an inclination to the viewing plane by means of an adapter, in that an electric drive is provided for rotating the imaging assembly, in that the folding of the beam path is carried out by the arrangement of the two mirrors in such a way that a polar angle of 45° is adjusted, in that the illumination is carried out perpendicular to and/or in direction of the beam path, and in that the controlling of the video camera, the mirror illumination unit, the illumination unit, and electric drive is carried out by the controlling and regulating unit integrated in the assembly. Further advantageous embodiments are indicated in the patent claims.

### BRIEF DESCRIPTION OF THE DRAWINGS

The invention will be explained more fully in the following with reference to embodiment examples. The drawings show:

FIG. 1 a schematic view of the arrangement according to the invention; and

FIG. 2 a schematic diagram showing the control.

### DESCRIPTION OF THE EMBODIMENTS

An arrangement is proposed for oblique imaging and illumination of an object on a plane surface from optional azimuth angles between 0° and 360°.

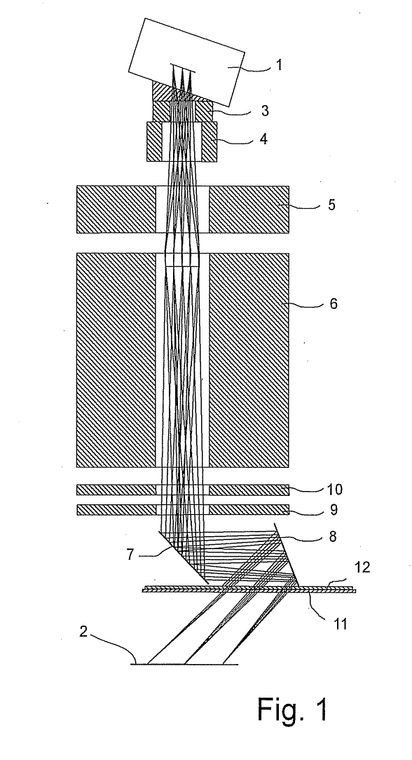

The arrangement according to FIG. 1 comprises a video camera 1 which is inclined at a defined angle relative to the viewing plane 2. An objective 4 is attached to the camera 1 by a mechanical adapter 3. The objective 4 is perpendicular to the viewing plane 2. The mirror 7 and combined mirror illumination unit 8 assemblies fold the beam path and guide it to the viewing plane 2 at an angle of 45°. The illumination unit 9 and the combined mirror illumination unit 8 generate the light needed for viewing. Thanks to this arrangement, the viewing plane 2 can be illuminated perpendicular to and/or from the viewing direction.

The controlling of the video camera 1, illumination unit 9 and combined mirror illumination unit 8 is carried out by means of a controlling and regulating unit 10. The image capture module in its entirety (as is shown in FIG. 1) is completely enclosed by a protective hood, not shown. In this way, combined with a cover glass 11, a one hundred percent protection against dust is achieved. Accordingly, a hermetically closed system is formed. To improve the illumination characteristics, a diffusion disk 12 is installed in the cover glass 11.

The entire arrangement comprising video camera 1, adapter 3, objective 4, mirror 7, mirror illumination unit 8, illumination unit 9, controlling and regulating unit 10, cover glass 11, and diffusion disk 12 is fastened to the rotor of a hollow shaft motor 6. Owing to the rotation of the rotor of the hollow shaft motor 6, the viewing direction can be selected between 0° and 360° (azimuth angle).

A rotary cable carrier group 5 is located above the hollow shaft motor 6 for cable feed to the rotating electric assemblies comprising video camera 1, mirror illumination unit 8, illumination unit 9 and controlling and regulating unit 10. The cable carrier group 5 comprises seven rotatably mounted, interconnected planes. When the system rotates by a defined azimuth angle, this rotational angle is distributed to the individual planes. The relative movement of a plane with respect to the plane above it is approximately 52° during a complete rotation. Accordingly, it is possible to realize a cable guide of this kind within a very compact installation space and to reduce the strain on the guided lines to a minimum.

In an automatic optical inspection system, the arrangement according to FIG. 1 is fastened to an X-Y positioning system. This allows the entire arrangement according to FIG. 1 to be moved to any location on the printed circuit board to be inspected and, after the units comprising video camera 1, adapter 3, objective 4, mirror 7, mirror illumination unit 8, illumination unit 9, controlling and regulating unit 10, cover glass 11, and diffusion disk 12 are rotated to this location, makes it possible to acquire images of the object under inspection from any azimuth angles between 0° and 360°, to transmit these images to an evaluating and controlling unit 13, and to evaluate them therein.

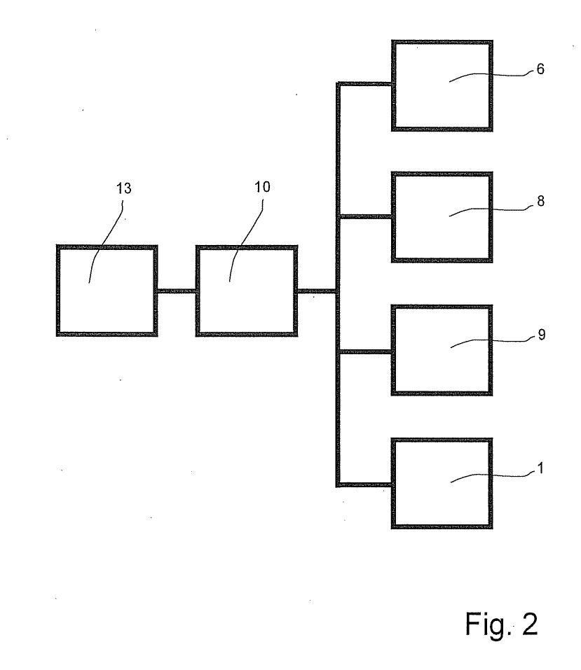

The control of the arrangement according to FIG. 1 is realized in the following manner as shown in FIG. 2:

A central evaluating and control unit 13 sends a command to the controlling and regulating unit 10 containing the reference azimuth angle at which an image is to be acquired (value range 0°-360°) and type of illumination. The controlling and regulating unit 10 sends a movement command to the hollow shaft motor 6. After the position angle is reached, the desired illumination is switched on simultaneously by the controlling and regulating unit 10, and the image recording of the video camera 1 is started. At the conclusion of image recording by the video camera 1, the image is sent to the central evaluating and control unit 13.

### REFERENCE NUMBERS

1 video camera

2 viewing plane

3 adapter

4 objective

5 rotary cable carrier group

6 hollow shaft motor

7 mirror

8 mirror illumination unit

9 illumination unit

10 controlling and regulating unit

11 cover glass

12 diffusion disk

13 central evaluating and control unit

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. An arrangement of a rotary image capture unit for imaging objects on printed circuit boards, preferably at a polar viewing angle of 45° with respect to a viewing plane, comprising
a) an imaging assembly comprising a cable feed, a video camera, an adapter, an objective, a mirror, a mirror illumination unit, an illumination unit, a controlling and regulating unit, a cover glass, and a diffusion disk is arranged so as to be rotatable in its entirety at an angle between 0° and 360°,
b) the said video camera being arranged at an inclination to said viewing plane by means of an adapter,
c) an electric drive for rotating the imaging assembly,
d) two mirrors for folding of the beam path and arranged so that a polar angle of 45° is adjusted,
e) illumination being arranged perpendicular to and/or in direction of the beam path,
f) said controlling and regulating unit being arranged for controlling said video camera, said mirror illumination unit, said illumination unit, and said electric drive, and is integrated in the assembly.

2. The arrangement according to claim 1, wherein any rotational range between 0° and 360° can be adjusted.

3. The arrangement according to claim 1, wherein said electric drive is constructed as a hollow shaft motor with or without path limiting.

4. Arrangement The arrangement according to claim 3, wherein said hollow shaft motor is constructed with a path measuring system for position acquisition and position control.

5. The arrangement according to claim 3, wherein said hollow shaft motor is constructed as an electric stepper motor.

6. The arrangement according to claim 3, wherein said hollow shaft motor is constructed as an electric AC or DC servomotor.

7. The arrangement according to claim 3, wherein said hollow shaft motor is constructed as a rotary motor or as a linear motor.

8. The arrangement according to claim 1, wherein said electric drive is constructed as a motor without hollow shaft.

9. The arrangement according to claim 1, wherein said rotation is carried out by a pneumatic drive.

10. The arrangement according to claim 1, wherein said control of the drive, illumination and video camera is carried out outside the assembly.

11. The arrangement according to claim 1, wherein the polar angle can be adjusted by means of the arrangement of said mirror and of the mirror illumination unit and of the modified inclined position of the video camera.

12. The arrangement according to claim 1, wherein the polar angle can assume any value between 0° and 90°.

13. The arrangement according to claim 1, further comprising a prism or a mirror-prism assembly used for folding the beam path.

14. The arrangement according to claim 1, wherein said objective is a telecentric objective.

15. The arrangement according to claim 1, wherein said objective is a zoom objective.

16. The arrangement according to claim 1, wherein said objective is an entocentric objective.

17. The arrangement according to claim 1, wherein said video camera is a matrix camera.

18. The arrangement according to claim 1, wherein said video camera is a line camera.

19. The arrangement according to claim 1, further comprising LEDs having colors in different wavelength regions used for the illumination.

20. The arrangement according to claim 1, further comprising LEDs having colors in only one wavelength region used for the illumination.

21. The arrangement according to claim 1, wherein said illumination is carried out with continuous illumination.

22. The arrangement according to claim 1, wherein said illumination is carried out as flash illumination synchronized with the image capture of the video camera.

23. The arrangement according to claim 1, wherein said cable feed is carried out by means of a cable carrier group.

24. The arrangement according to claim 1, wherein said cable feed is carried out by means of a brush contact system.

25. The arrangement according to claim 1, further comprising a power supply and signal feed carried out by means of a wireless system.

26. The arrangement according to claim 1, further comprising a power supply and signal feed carried out by means of a combined wireless/brush contact/cable carrier system.

27. The arrangement according to claim 1, further comprising fans or Peltier elements used for cooling the assembly.

28. The arrangement according to claim 1, wherein said illumination is carried out from different directions.
